(19) United States
(12) Patent Application Publication
(10) Pub. No.: US 2012/0079087 A1
(43) Pub. Date: Mar. 29, 2012

(54) ONLINE HELP SYSTEM USING SESSION DETAILS

(75) Inventors: Partha Sarathi Mukherjee, San Jose, CA (US); Cheng-Mu Wen, San Jose, CA (US); Ping Hu, San Jose, CA (US); Qi Hu, Cupertino, CA (US); Xiangdong Ke, Cupertino, CA (US); Suresh Ganjigunta, San Jose, CA (US)

(73) Assignee: EBAY INC., San Jose, CA (US)

(21) Appl. No.: 12/891,537

(22) Filed: Sep. 27, 2010

(51) Int. Cl. G06F 15/173

(52) U.S. Cl. 709/223

(57) ABSTRACT

An on-line help method is provided for a user involved in an on-line session. A plurality of session details related to the on-line session, a help request from the user, and session identification information are received during the on-line session. The plurality of session details are retrieved using the session identification information, and agent help information that includes the plurality of session details is created. The agent help information is associated with the help request and sent to a help agent device. In an embodiment, the agent help information includes a plurality of web pages navigated by the user during the on-line session, and the plurality of web pages are organized according to an order in which the user navigated them. A help agent using the help agent device may use the agent help information to quickly and accurate diagnose any issues with the on-line session.

### BACKGROUND

1. Field of the Invention

The present invention generally relates to online payments and more particularly to a help system for online payments that utilizes user session details.

2. Related Art

More and more consumers are purchasing items and services over electronic networks such as, for example, the Internet. Consumers routinely search for and purchase products and services from merchants and individuals alike. The transactions may take place directly between an on-line merchant or retailer and the consumer, and payment is typically made by entering credit card or other financial information. Transactions may also take place with the aid of an on-line payment provider such as, for example, PayPal, Inc. of San Jose, Calif. Such payment providers can make transactions easier and safer for the parties involved. Purchasing through the Internet from the convenience of a consumer's home, office, or virtually anywhere (with mobile devices) is one main reason why on-line purchases are growing faster and faster.

However, issues can arise during the course of purchasing items or services over electronic networks that can confuse the consumer, interrupt the process, and ultimately even prevent the purchase from being made. It is advantageous for the merchant and/or the on-line payment provider to correct these issues as quickly as possible so that the consumers do not lose interest in making the purchase or lose faith in the on-line purchasing system, which can result in lost sales.

Conventionally, the merchant or on-line payment provider will provide an on-line help system that allows the customer to request help if an issue arises during an on-line purchasing session. The customer is typically allowed to request help through the electronic network and possibly contact the merchant or on-line payment provider over the phone to correct the issue. When the customer is connected to a help agent of the merchant and/or on-line payment provider using the help system, that customer is required to explain the issue to the help agent in detail in order for the help agent to determine how the issue arose and what methods to attempt in order to correct the issue. Such detailed issue explaining and the resulting issue diagnosis is time consuming and error-prone. Furthermore, the less technology-savvy the customer, the more difficult it will be for that customer to provide a detailed explanation that will allow the help agent to diagnose the issue. This can result in customer frustration, inability to correct the issue, and loss of sales.

Thus, there is a need for an improved help system for online payments.

### SUMMARY

According to one embodiment, a method for providing on-line help includes receiving, by a session server through a network, a plurality of session details related to a session involving a user; receiving, by a backend server through the network, a help request from a user and session identification information; retrieving, by a processor, the plurality of session details using the session identification information; creating, by the processor, agent help information that includes the plurality of session details; associating, by the processor, the agent help information with the help request; and sending the agent help information and the help request to a help agent device.

In an embodiment, the agent help information includes a plurality of web pages navigated by the user during the session, and the plurality of web pages are organized in the agent help information according to an order in which the user navigated the plurality of web pages. A help agent using the help agent device may use the agent help information to navigate through the plurality of web pages in the same order as the user in order to recreate the users session flow.

As a result, the help agent is able to personally experience the users session flow, which will allow the help agent to diagnose the issues with the session that caused the user to send the help request more quickly and easily than is possible with conventional help systems.

These and other features and advantages of the present disclosure will be more readily apparent from the detailed description of the embodiments set forth below taken in conjunction with the accompanying drawings.

### BRIEF DESCRIPTION OF THE FIGURES

FIG. 1a is a schematic view illustrating an embodiment of a networked system;

FIG. 1b is a schematic view illustrating an embodiment of a payment service provider involved in the networked system of FIG. 1a;

FIG. 2 is a schematic view illustrating an embodiment of a computer system used in the networked system of FIG. 1a and the payment service provider of FIG. 1b;

FIG. 3a; is a flow chart illustrating an embodiment of a method for providing on-line help;

FIG. 3b is a screenshot of an embodiment of a web page used in the method of FIG. 3a;

FIG. 3c is a screenshot of an embodiment of a web page used in the method of FIG. 3a;

FIG. 3d is a screenshot of an embodiment of a web page used in the method of FIG. 3a;

FIG. 3e is a screenshot of an embodiment of a web page used in the method of FIG. 3a; and

FIG. 3f is a screenshot of an embodiment of a web page used in the method of FIG. 3a.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

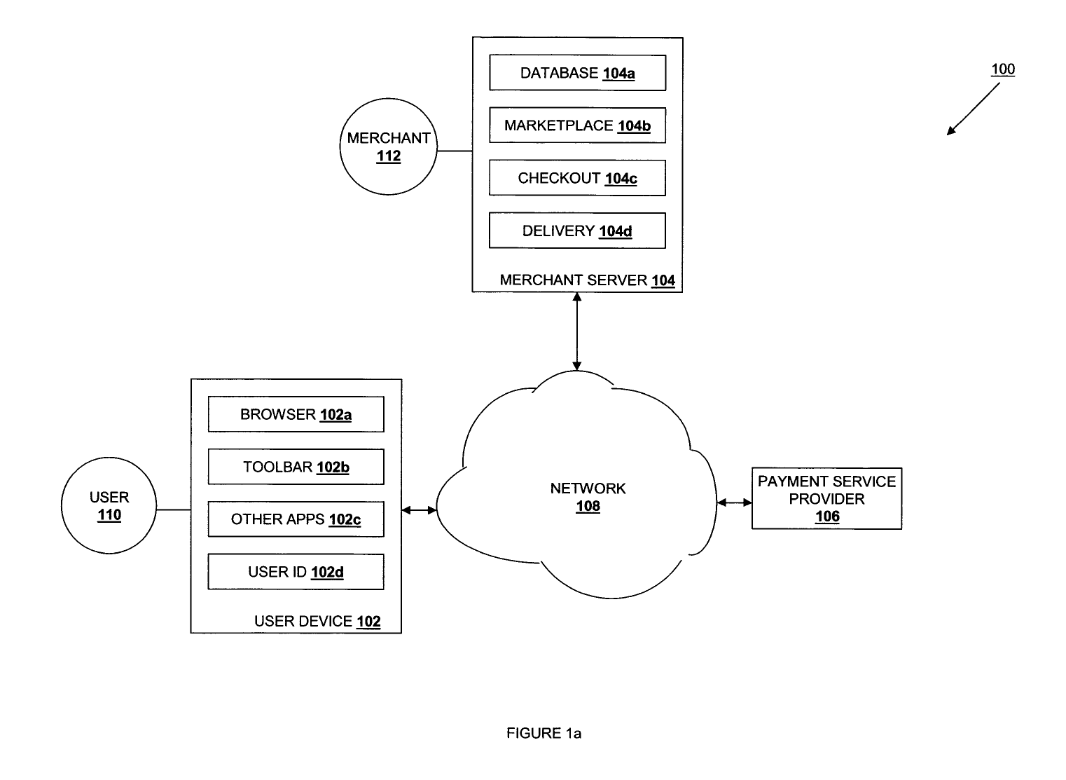

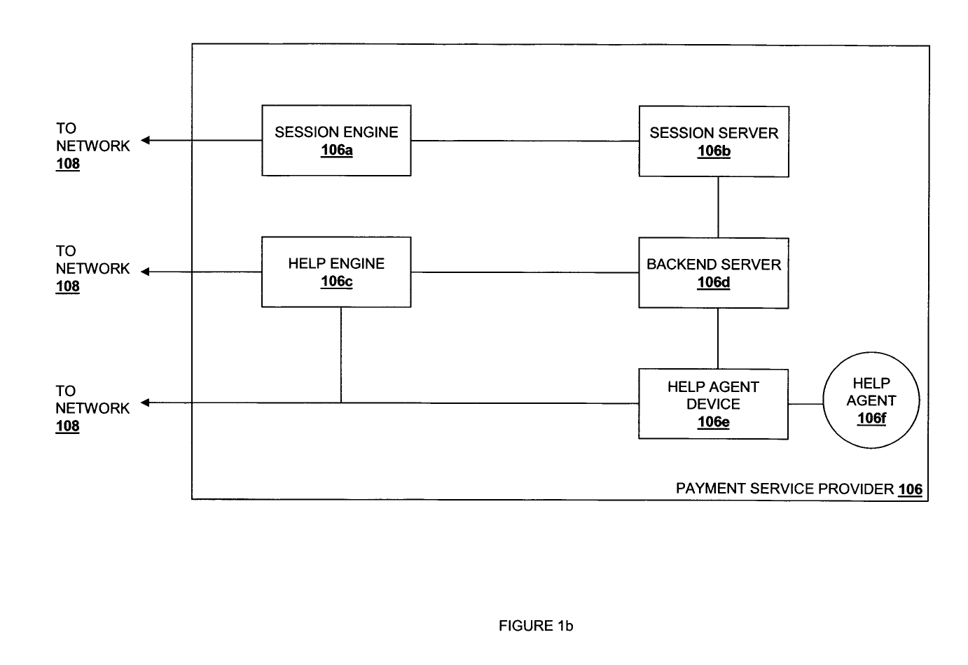

Referring now to FIG. 1a, an embodiment of a networked system 100 used to make on-line payments is illustrated. The networked system 100 includes a user device 102, a merchant server 104, and a payment service provider 106 in communication over a network 108. The payment service provider 106 may be a payment service provider such as, for example, PayPal Inc. of San Jose, Calif.

The user device 102, merchant server 104, and components of the payment service provider 106 (discussed in further detail below) may each include one or more processors, memories, and other appropriate components for executing instructions such as program code and/or data stored on one or more computer readable mediums to implement the various applications, data, and steps described herein. For example, such instructions may be stored in one or more computer readable mediums such as memories or data storage devices internal and/or external to various components of the system 100, and/or accessible over the network 108.

The network 108 may be implemented as a single network or a combination of multiple networks. For example, in various embodiments, the network 108 may include the Internet and/or one or more intranets, landline networks, wireless networks, and/or other appropriate types of networks.

The user device 102 may be implemented using any appropriate combination of hardware and/or software configured for wired and/or wireless communication over network 108. For example, in one embodiment, the user device 102 may be implemented as a personal computer of a user 110 in communication with the Internet. In other embodiments, the user device 102 may be a smart phone, personal digital assistant (PDA), laptop computer, and/or other types of computing devices.

As shown, the user device 102 may include one or more browser applications 102a which may be used, for example, to provide a convenient interface to permit the user 110 to browse information available over the network 108. For example, in one embodiment, the browser application 102a may be implemented as a web browser configured to view information available over the Internet.

The user device 102 may also include one or more toolbar applications 102b which may be used, for example, to provide user-side processing for performing desired tasks in response to operations selected by the user 110. In one embodiment, the toolbar application 102b may display a user interface in connection with the browser application 102a.

The user device 102 may further include other applications 102c as may be desired in particular embodiments to provide desired features to the user device 102. In particular, the other applications 102c may include a payment application for payments through the payment service provider 106. The other applications 102c may also include security applications for implementing user-side security features, programmatic user applications for interfacing with appropriate application programming interfaces (APIs) over the network 108, or other types of applications. The other applications 102c may also include help applications for interacting with help agents in a help system, discussed in further detail below. Email and/or text applications may also be included, which allow the user 110 to send and receive emails and/or text messages through the network 108. The user device 102 includes one or more user and/or device identifiers 102d which may be implemented, for example, as operating system registry entries, cookies associated with the browser application 102a, identifiers associated with hardware of the user device 102, or other appropriate identifiers, such as a phone number. In one embodiment, the user identifier 102d may be used by the payment service provider 106 to associate the user 110 with a particular account maintained by the payment service provider 106 as further described herein.

The merchant server 104 may be maintained, for example, by an on-line merchant, digital goods seller, individual seller, and/or application developer offering various products and/or services in exchange for payment to be received over the network 108, including digital goods and applications. In this regard, the merchant server 104 includes a database 104a identifying available products and/or services (e.g., collectively referred to as items) which may be made available for viewing and purchase by the user 110. Accordingly, the merchant server 104 also includes a marketplace application 104b which may be configured to provide information over the network 108 to the browser 102a of the user device 102. For example, in one embodiment, the user 110 may interact with the marketplace application 104b through the browser application 102a over the network 108 in order to search and view various items identified in the database 104a.

The merchant server 104 also includes a checkout application 104c which may be configured to facilitate the purchase by the user 110 of items identified by the marketplace application 104b. The checkout application 104c may be configured to accept payment information from the user 110 and/or from the payment service provider 106 over the network 108.

In one embodiment, the merchant server 104 further includes a delivery application 104d which may be configured to deliver a digital or downloadable item to the user device 102. For example, if the user 110 purchases a downloadable item or enhancement from a merchant 112 through the merchant server 104, the delivery application 104d has the ability to transmit or download the item onto the user device 102 or allow additional access to the user 110 after payment is confirmed (e.g., by the payment service provider 106.)

Referring now to FIGS. 1a and 1b, an embodiment of the payment service provider 106 is illustrated in more detail. A session engine 106a which may be, for example, software stored on a computer-readable medium, is included in the payment service provider 106 and is operably coupled to the network 108 and a session server 106b. In an embodiment, the session server 106b includes computer-readable media, databases, and other computing components known in the art that allow the session server 106b to manage and record the details of on-line payment sessions that are conducted through the network 108 with the payment service provider 106. In an embodiment, the session engine 106a and the session server 106b may be combined into a single component of the payment service provider 106 rather than separate components as illustrated in FIG. 1b. In an embodiment, the session server 106b is a Mayfly server. A help engine 106c which may be, for example, software stored on a computer-readable medium, is included in the payment service provider 106 and is operably coupled to the network 108 and a backend server 106d. In an embodiment, the backend server 106d includes computer-readable media, databases, and other computing components known in the art that allow the backend server 106d to receive session identifying details (discussed in further detail below), help requests, and other information that is sent through the network 108 (e.g., to the help engine 106c) and use that information to create agent help information (discussed in further detail below). In an embodiment, the help engine 106c and the backend server 106d may be combined into a single component of the payment service provider 106 rather than separate components as illustrated in FIG. 1b. In an embodiment, the session server 106b and the backend server 106d may be combined into a single component of the payment service provider 106 (e.g., a single server) rather than separate components as illustrated in FIG. 1b. A help agent device 106e is coupled to the help engine 106c and the backend server 106d and may be implemented using any appropriate combination of hardware and/or software configured for wired and/or wireless communication over network 108. For example, in one embodiment, the help agent device 106e may be implemented as a computer of a help agent 106f in communication with the network 108.

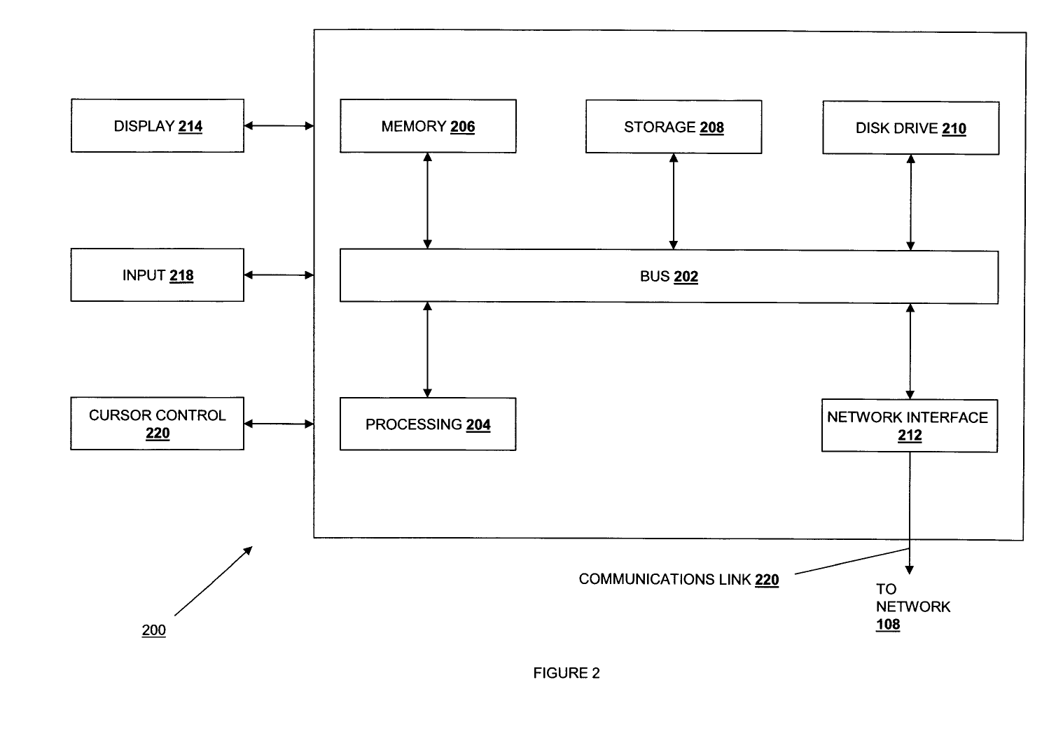

Referring now to FIG. 2, an embodiment of a computer system 200 suitable for implementing one or more embodiments of the present disclosure is illustrated. In various implementations, the user device 102 and help agent device 106e may comprise a computing device (e.g., a computer, laptop, smart phone, PDA, etc.) capable of communicating with the network 108. The merchant server 104, session server 106b, backend server 106d, and/or other components of the system 100 may utilize a network computing device (e.g., a network server) capable of communicating with the network 108. It should be appreciated that each of the devices utilized by users, merchants, payment providers, and help agents may be implemented as the computer system 200 in a manner as follows.

In accordance with various embodiments of the present disclosure, computer system 200, such as a computer and/or a network server, includes a bus 202 or other communication mechanism for communicating information, which interconnects subsystems and components, such as a processing component 204 (e.g., processor, micro-controller, digital signal processor (DSP), etc.), a system memory component 206 (e.g., RAM), a static storage component 208 (e.g., ROM), a disk drive component 210 (e.g., magnetic or optical), a network interface component 212 (e.g., modem or Ethernet card), a display component 214 (e.g., CRT or LCD), an input component 218 (e.g., keyboard, keypad, or virtual keyboard), and a cursor control component 220 (e.g., mouse, pointer, or trackball). In one implementation, the disk drive component 210 may comprise a database having one or more disk drive components.

In accordance with embodiments of the present disclosure, the computer system 200 performs specific operations by the processor 204 executing one or more sequences of instructions contained in system the memory component 206, such as described herein with respect to the user 110, the merchant 112 the payment service provider 106, and/or the help agent 106f. Such instructions may be read into the system memory component 206 from another computer readable medium, such as the static storage component 208 or the disk drive component 210. In other embodiments, hard-wired circuitry may be used in place of or in combination with software instructions to implement the present disclosure.

Logic may be encoded in a computer readable medium, which may refer to any medium that participates in providing instructions to the processor 204 for execution. Such a medium may take many forms, including but not limited to, non-volatile media, volatile media, and transmission media. In various implementations, non-volatile media includes optical or magnetic disks, such as the disk drive component 210, volatile media includes dynamic memory, such as the system memory component 206, and transmission media includes coaxial cables, copper wire, and fiber optics, including wires that comprise the bus 202. In one example, transmission media may take the form of acoustic or light waves, such as those generated during radio wave and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read.

In various embodiments of the present disclosure, execution of instruction sequences to practice the present disclosure may be performed by the computer system 200. In various other embodiments of the present disclosure, a plurality of the computer systems 200 coupled by a communication link 220 to the network 108 (e.g., such as a LAN, WLAN, PTSN, and/or various other wired or wireless networks, including telecommunications, mobile, and cellular phone networks) may perform instruction sequences to practice the present disclosure in coordination with one another.

The computer system 200 may transmit and receive messages, data, information and instructions, including one or more programs (i.e., application code) through the communication link 220 and the network interface component 212. The network interface component 212 may include an antenna, either separate or integrated, to enable transmission and reception via the communication link 220. Received program code may be executed by processor 204 as received and/or stored in disk drive component 210 or some other non-volatile storage component for execution.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the scope of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

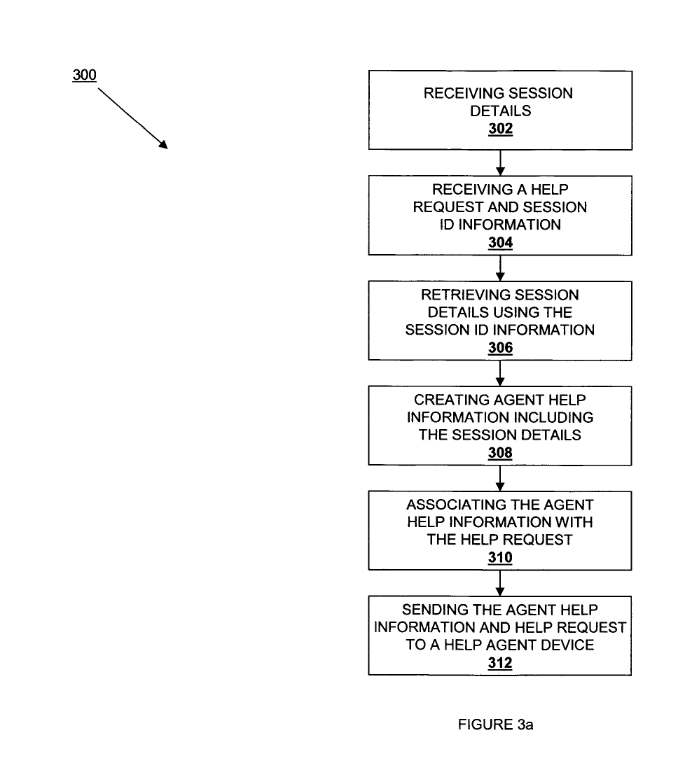

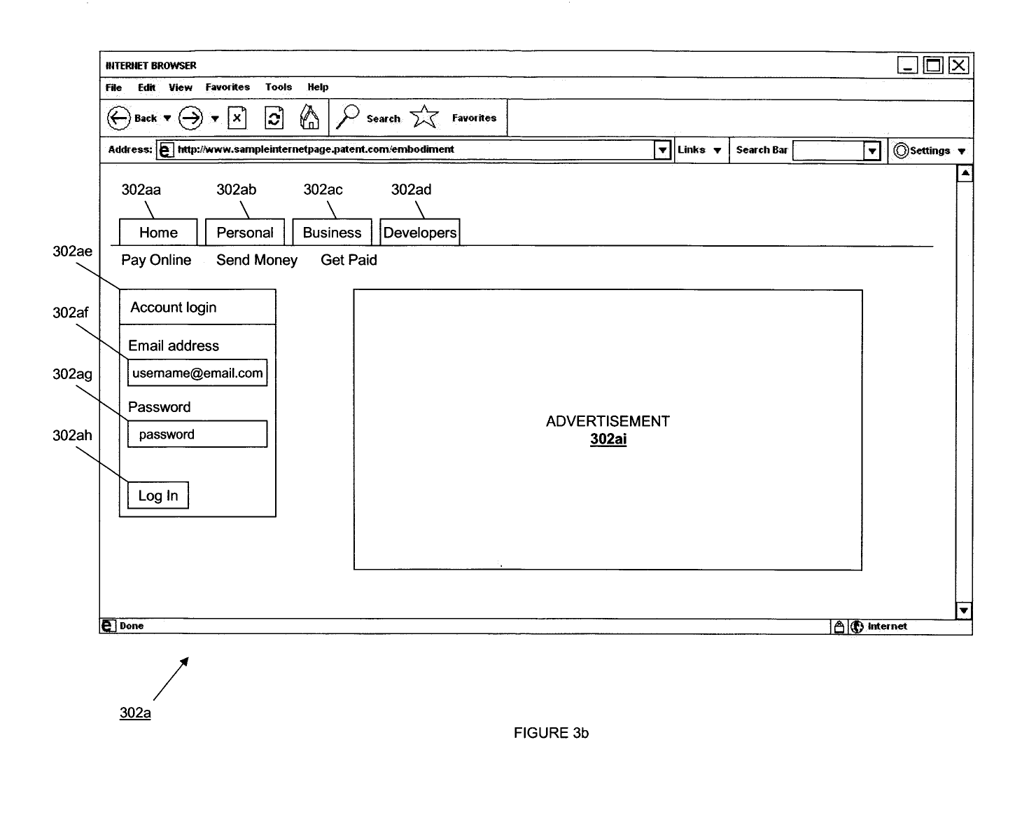

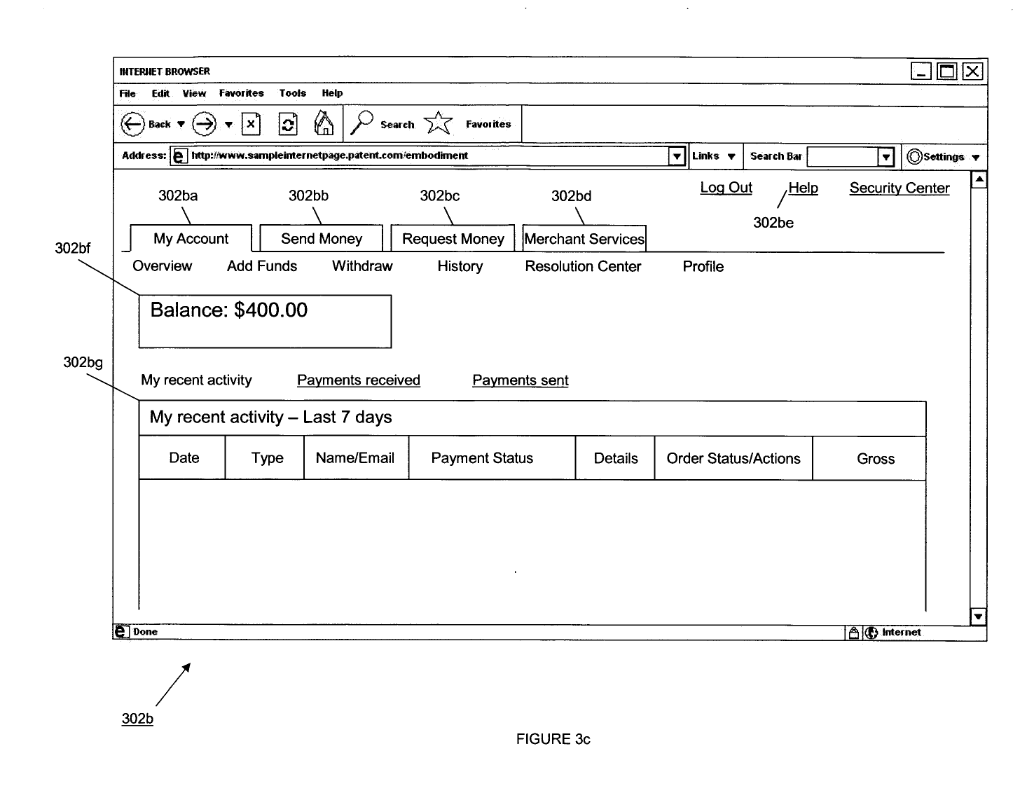

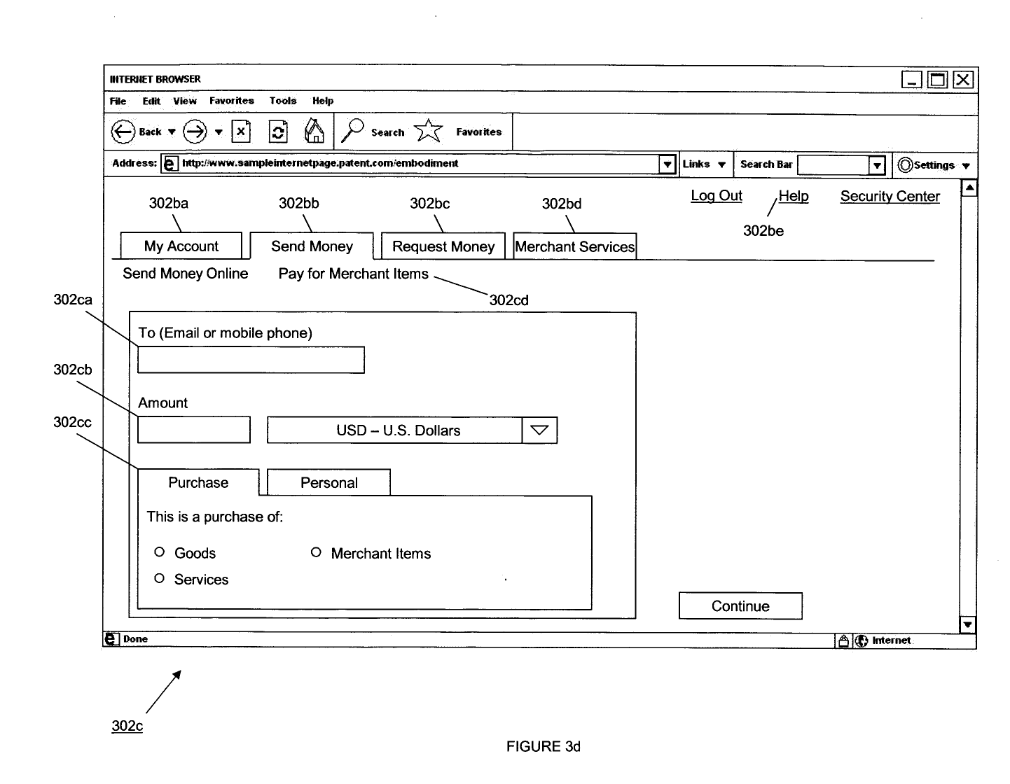

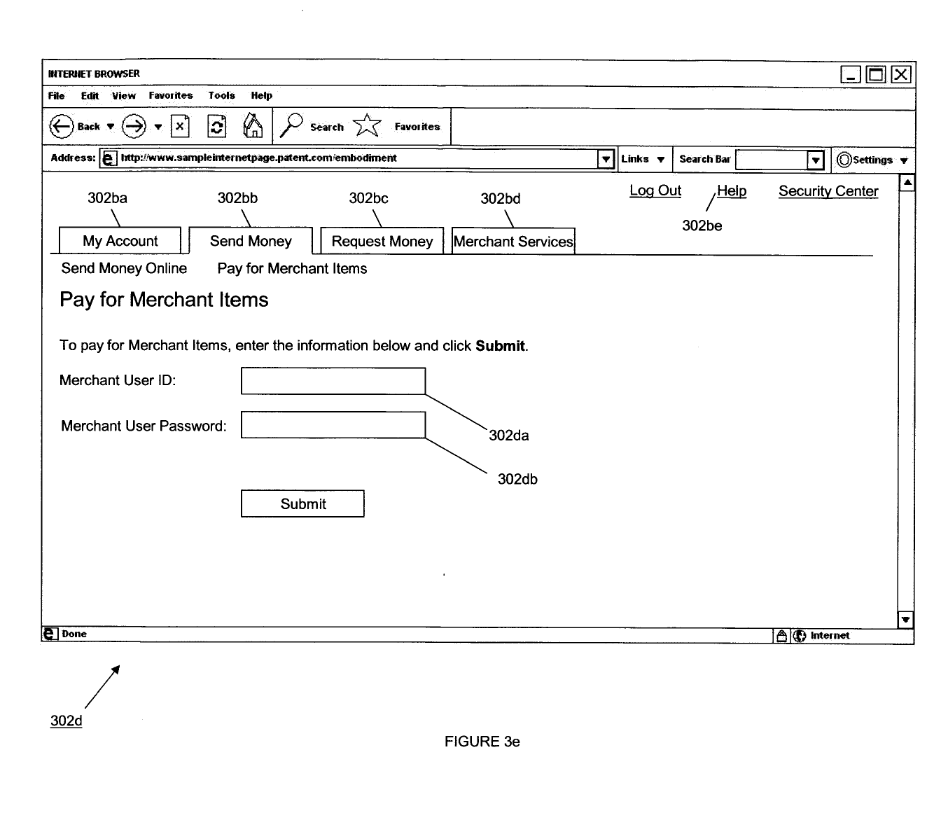

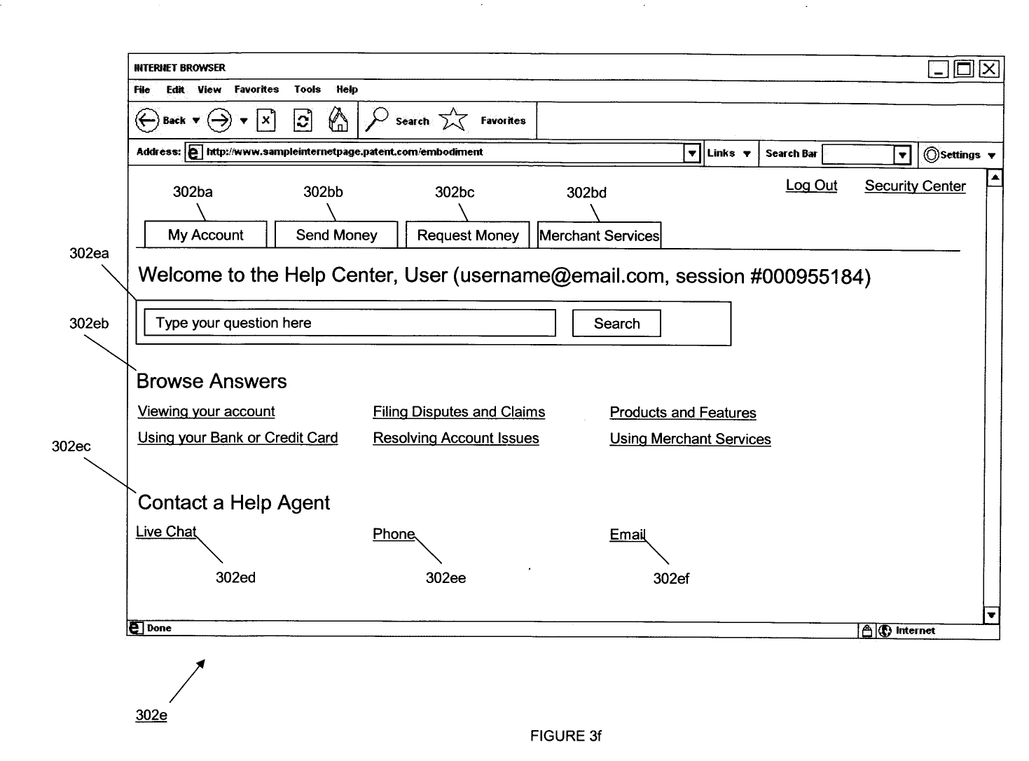

Referring now to FIGS. 3a, 3b, 3c, 3d, and 3e, a method 300 for providing on-line help is illustrated. The method 300, shown in FIG. 3a, begins at block 302 where session details are received. In an embodiment, the user 110, described above with reference to FIG. 1a, may begin or be involved in an on-line shopping session using the user device 102, the network 108, and the merchant server 104, all described above with reference to FIGS. 1a and 2. For example, the user 110 may use the browser application 102a to connect to the marketplace application 104b on the merchant server 104 through the network 108 and shop the marketplace application 104b for items included in the database 104a, as is known in the art. As is also known in the art, the user 110 may use the browser application 102a to select one or more items that the user 110 wishes to purchase. In an embodiment, when the user 110 is finished shopping, the user 110 may be connected, through the network 108, to the checkout application 104c on the merchant server 104 in order to provide payment for the items selected during the on-line shopping session. While the on-line shopping session has been described above as involving the user 110 connecting to the merchant server 104, one of skill in the art will recognize that the present disclosure is not so limited, and that a variety of different on-line shopping sessions known in the art fall within its scope.

In an embodiment, in order to provide payment for the items selected during the on-line shopping session, the user 110 may be connected to the payment service provider 106 such that the payment service provider 106 may provide payment to the merchant 112 (though, e.g., the checkout application 104c) for the items selected by the user 110 during the on-line shopping session. While the description below is directed to this scenario where the payment service provider 106 provides payment for the user 110 to the merchant 112, one of skill in the art will recognize that the disclosure is not so limited, and the method 300 for providing on-line help may be applied to the scenario where the user 110 provides payment directly to the merchant 112 or other payee, and/or to a variety of other help system scenarios that operate over a network while remaining within the scope of the present disclosure. However, in the illustrated embodiment, the user 110 is connected through the network 108 to the session engine 106a in the payment service provider 106. In an embodiment, upon connecting to the payment service provider 106, the user 110 may be presented with a payment service provider log-on web page 302a through the browser application 102a on the user device 102, as illustrated in FIG. 3b.

The log-on web page 302a may be one of a plurality of web pages in a website provided by the payment service provider 106, and includes a plurality of website navigation tabs such as, for example, a home navigation tab 302aa, a personal navigation tab 302ab, a business navigation tab 302ac, and a developers navigation tab 302ad, each which allow the user 110 to navigate to different web pages on the website. The log-on web page 302a also includes a user log-on section 302ae having a user identification field 302af, a user password field 302ag, and a log-in button 302ah. The log-on web page may also include one or more advertisements 302ai. The user 110 may (e.g., through the browser application 102a using the user device 102) provide a user identification (e.g., in the illustrated embodiment, the email address such as “username@email.com) in the user identification field 302af and a password (e.g., in the illustrated embodiment, “password”) in the user password field 302ag and select the log-in button 302ah in order to log-on to a previously set-up user account with the payment service provider 106. In another embodiment, the user 110 may create a user account with the payment service provider 106, as is known in the art, upon being connected to the log-on web page 302a of the payment service provider 106.

Upon connecting to the user account, an on-line payment session has begun for the user 110, and the session engine 106a begins recording session details that are related to the on-line payment session being conducted by the user 110 and sending those session details to the session server 106b. As will be explained in further detail below, the on-line payment session that begins upon the user 110 connecting to the user account with the payment service provider 106 will continue until the user 110 is disconnected from the user account with the payment service provider 106 (e.g., by logging off of the user account, as is known in the art) and the session details are recorded and sent to the session server 106b by the session engine until such a disconnection. In an embodiment, the session details may include the web pages selected by the user 110 during the on-line payment session, information entered into web pages by the user 110 during the on-line payment session, links selected by the user 110 during the on-line payment session, all information received from the user 110 through the network 108 by the payment service provider 106 during the online-payment session, and a variety of other session details known in the art.

An embodiment of an on-line payment session will now be described. However, one of skill in the art will recognize that the embodiment below is presented merely as an example, and a variety of different web pages and/or other information may be exchanged between the user 110 and the payment service provider 106 which is not discussed below but which would fall within the scope of the present disclosure. In the illustrated embodiment, upon connecting to the user account and beginning the on-line payment session, the user 110 may be presented (e.g., through the browser application 102a on the user device 102) with an account web page 302b, as shown in FIG. 3c.

The account web page 302b may be one of the plurality of web pages in the website provided by the payment service provider 106, and includes a plurality of account navigation tabs such as, for example, a my account navigation tab 302ba, a send money navigation tab 302bb, a request money navigation tab 302bc, and a merchant services navigation tab 302bd, each which allows the user 110 to navigate to different web pages related to the user account of the user 110. The account web page 302b also includes a help link 302be that, as described in further detail below, may be included on each web page related to the user account of the user 110 and that the user 110 may select to request help if an issue arises with the on-line payment session.

The account web page 302b may also include a balance section 302bf that shows the balance of money in the user account of the user 110 and a recent activity section 302bg that shows the recent activity in the user account of the user 110. The account web page 302b may include a variety of other links and web page components known in the art, some of which are illustrated but not described for clarity of discussion, without departing from the scope of the present disclosure. In an embodiment, the user 110 may select the send money navigation tab 302ad in order to attempt to, for example, send money to the merchant 112. As described above, the session engine 106a may record session details of the on-line payment session that include the account web page 302b, information entered into the account web page 302b, links or tabs selected on the account web page 302b, any information sent to the payment service provider 106 using the account web page 302b, and/or a variety of other session detail information known in the art, and send those session details to the session server 106b.

Upon selecting the send money navigation tab 302ad, the user 110 may be presented (e.g., through the browser application 102a on the user device 102) with a send money web page 302c, as shown in FIG. 3d. The send money web page 302c may be one of the plurality of web pages in the website provided by the payment service provider 106, and includes the plurality of account navigation tabs 302ba, 302bb, 302bc, and 302bd. The send money web page 302c also includes the help link 302be. The send money web page 302c may also include a to field 302ca, an amount field 302cb, and a purchase type field 302cc that together allow the user 110 to send an amount of money to someone and categorize what the money is being sent for.

The send money web page 302c also includes a Pay for Merchant Items link 302cd that may, for example, allow the user 110 to pay the merchant 112 for items selected during the on-line shopping session, discussed above. The send money web page 302 may include a variety of other links and web page components known in the art, some of which are illustrated but not described for clarity of discussion, without departing from the scope of the present disclosure. In an embodiment, the user 110 may select the Pay for Merchant Items link 302cd in order to attempt to, for example, send money to the merchant 112. As described above, the session engine 106a may record session details of the on-line payment session that include the send money web page 302c, information entered into the send money web page 302c, links or tabs selected on the send money web page 302c, any information sent to the payment service provider 106 using the send money web page 302c, and/or a variety of other session detail information known in the art, and send those session details to the session server 106b.

Upon selecting the Pay for Merchant Items link 302cd, the user 110 may be presented (e.g., through the browser application 102a on the user device 102) with a Pay for Merchant Items web page 302d, as shown in FIG. 3d. The Pay for Merchant Items web page 302d may be one of the plurality of web pages in the website provided by the payment service provider 106, and includes the plurality of account navigation tabs 302ba, 302bb, 302bc, and 302bd. The Pay for Merchant Items web page 302d also includes the help link 302be. The send money web page 302c may also include a merchant user ID field 302da and Merchant User Password field 302db that together may allow the user 110 and/or the payment service provider 106 to connect to the merchant server 104 to pay the merchant 112 for items selected during the on-line shopping session, discussed above. The Pay for Merchant Items web page 302d may include a variety of other links and web page components known in the art, some of which are illustrated but not described for clarity of discussion, without departing from the scope of the present disclosure. As described above, the session engine 106a may record session details of the on-line payment session that include the Pay for Merchant Items web page 302d, information entered into the Pay for Merchant Items web page 302d, links or tabs selected on the Pay for Merchant Items web page 302d, any information sent to the payment service provider 106 using the Pay for Merchant Items web page 302d, and/or a variety of other session detail information known in the art, and send those session details to the session server 106b.

As is known in the art, the user 110 may commit errors when navigating through the web page (e.g., the web pages 302a, 302b, 302c, and 302d) that make up the website of the payment service provider 106, and these errors can result in issues with the on-line payment session that confuse the user 110 or make it so the user 110 cannot complete the payment to the merchant 112. For example, the user 110 may select an incorrect link that does not take the user 110 to a web page that allows the user 110 to pay the merchant 112 (e.g., the request money navigation tab 302bc), the user 110 may enter the wrong information in one of the fields (e.g., the merchant user ID field), and/or a variety of other errors known in the art. Furthermore, other errors known in the art may occur (e.g., with regards to the web pages, website, and/or the network 108) that can also confuse the user or otherwise make it so the user 110 cannot complete the payment to the merchant 112. In such situations when these issues, or other issues known in the art that tend to cause user confusion or threatening the completion of a payment, the user 110 may select the help link 302be at any point during the on-line payment session.

In the event the user 110 selects the help link 302be, the user 110 may be presented (e.g., through the browser application 102a on the user device 102) with a help web page 302e, as shown in FIG. 3f. The help web page 302e may be one of the plurality of web pages in the website provided by the payment service provider 106, and includes the plurality of account navigation tabs 302ba, 302bb, 302bc, and 302bd. The help web page 302e also includes a help search field 302ea, a help answer section 302eb, and a help agent contact section 302ec. The help agent contact section 302ec may include a live chat link 302ed, a phone link 302ee, an email link 302ef, and/or a variety of other help links known in the art. The help web page 302e may include a variety of other links and web page components known in the art, some of which are illustrated but not described for clarity of discussion, without departing from the scope of the present disclosure.

As described above, the session engine 106a may record session details of the on-line payment session that include the help web page 302e, information entered into the help web page 302e, links or tabs selected on the help web page 302e, any information sent to the payment service provider 106 using the help web page 302e, and/or a variety of other session detail information known in the art, and send those session details to the session server 106b.

Referring back to FIG. 3a, the method 300 then proceeds to block 304 where a help request and session identification information are received. In an embodiment, the user 110 (e.g., through the browser application 102a on the user device 102) may select any of the live chat link 302ed, the phone link 302ee, or the email link 302ef in the help agent contact section 302ec of the help web page 302e. Selecting any of the links 302ed, 302ee, or 302ef sends a help request to the help engine 106c through the network 108. In response to receiving the help request, the help engine 106c captures session identification information from the help web page 302e and sends the help request and the session identification information to the backend server 106d. In an embodiment, the session identification information may include a user identification (e.g., an email address such as username@email.com, discussed above), a session identification that identifies the on-line payment session being conducted by the user 110, both the user identification and session identification, and/or a variety of other session identification information known in the art. In an embodiment, the session identification information may be captured as displayed on the help web page 302e (e.g., by ‘screenscraping’ or other means to capture “username@email.com” and “session #000955184” displayed on the help web page 302e, as is illustrated in FIG. 3f), by reading information associated with but not displayed on the help web page 302e (e.g., metadata or other data associated with the help web page 302e), and or using a variety of other capturing methods known in the art. In an embodiment, the user 110 may provide the user identification before and/or during the selection of one of the links 302ed, 302ee, or 302ef.

The method 300 then proceeds to block 306 where session details are retrieved using the session identification information. In an embodiment, the backend server 106 uses the session identification information received in block 304 of the method 300 to retrieve the session details of the on-line payment session, discussed above, from the session server 106b. For example, the backend server 106d may search the session server 106b for on-line payment sessions involving the user 110 by using a user identification that is part of the session identification information and retrieve the most recent on-line payment session from that user 110. In another example, the backend server 106d may search the session server 106b for on-line payment sessions involving the user 110 by using a session identification that is part of the session identification information and retrieve the on-line payment session that corresponds to that session identification. In yet another example, the backend server 106d may search the session server 106b for on-line payment sessions involving the user 110 by using a user identification and a session identification that are part of the session identification information and retrieve the on-line payment session that corresponds to that user identification and session identification.

The method 300 then proceeds to blocks 308 and 310 where agent help information is created that includes the session details, and that agent help information is associated with the help request. In an embodiment, the backend server 106d uses the session details retrieved in block 306 of the method 300 to create agent help information that may include any or all of the information included in the session details. For example, the agent help information may include the plurality of web pages navigated by the user 110 during the on-line payment session during which the help request was made. In another example, the agent help information may include the plurality of web pages navigated by the user 110 during the on-line payment session during which the help request was made, and those web pages may be organized according to the chronological order in which the user 110 navigated them (e.g., if the user 110 navigated the web pages in the order discussed above, the agent help information would include those web pages in that chronological order). In another example, the agent help information may include other session details discussed above such as information entered on web pages, links selected on web pages, any information sent to the payment service provider 106 using the website, etc., and those session details may be organized according to the chronological order in which the user generated them (e.g., if the user entered something into a field on one of the web pages, and then selected a link, the agent help information would indicate the chronological order in which those occurred.) In an embodiment, the web pages and/or other information may be referred to as the ‘session flow’ of the on-line payment session when it is organized in the chronological order in which the user navigated or generated it. In an embodiment, the backend server 106d then associates that agent help information with the help request.

The method 300 then proceeds to block 312 where the agent help information and the help request are sent to a help agent device. In an embodiment, the backend server 106d then sends the agent help information, created in block 310 of the method 300, and the help request, received in block 304 of the method 300 and associated with the agent help information in block 310 of the method 300, to the agent help device 106e. The help agent 106f may then use the help agent device 106e to view the agent help information. In an embodiment, the help agent 106f may use the agent help information to view the web pages navigated by the user 110 during the on-line payment session. In an embodiment, the help agent 106f may use the agent help information to view the session flow for the on-line payment session (e.g., the plurality of web pages navigated by the user 110 during the on-line payment session in the same order in which the user 110 navigated them.) In an embodiment, the help agent 106f may use the agent help information to recreate any or all of the session details (information entered into the web pages, links selected, etc.) generated by the user 110 during the on-line payment session (e.g., the session flow.) For example, the help agent device 106e may provide the help agent 106f with a help application that allows the help agent 106f to communicate with the user 110 through the network 108 while moving through the session flow of the on-line payment session that was included in the agent help information.

Use of the agent help information allows the help agent 106f to experience what the user 110 experienced that led to the issue with the on-line payment session, and thus helps the help agent 106f to determine how the issue arose. Combined with other details that may be included (e.g., in the help request) the agent help information allows the help agent to quickly, accurately, and easily diagnose the issue for which the user 110 generated the help request. Depending on the link selected by the user 110, the help agent 106f may contact the user 110 by instant message (e.g., in the event the live chat link 302ed was selected), by phone (e.g., in the event the phone link 302ee was selected), by email (e.g., in the event the email link 302ef was selected), or by a variety of other methods known in the art, and help the user 110 such that the issue with the on-line payment session is resolved the user 110 may pay the merchant 112 to purchase the items selected during the on-line shopping session, discussed above.

Thus, a system and method for providing on-line help have been described that allow a help agent to quickly, accurately, and easily diagnose an issue that occurs with a user interacting over an electronic network by providing the help agent with agent help information that allows the help agent to recreate the experience of the user that led to the issue.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. For example, the above embodiments have focused on merchants and seller; however, a user or consumer can pay virtually, or otherwise interact with any type of recipient, including charities and individuals. The payment does not have to involve a purchase, but can be a loan, a charitable contribution, a gift, etc. Thus, merchant as used herein can also include charities, individuals, and any other entity or person receiving a payment from a user. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A method for providing on-line help, comprising:
receiving, by a session server through a network, a plurality of session details related to a session involving a user;
receiving, by a backend server through the network, a help request from a user and session identification information;
retrieving, by a processor, the plurality of session details using the session identification information;
creating, by the processor, agent help information that includes the plurality of session details;
associating, by the processor, the agent help information with the help request; and
sending the agent help information and the help request to a help agent device.

2. The method of claim 1, wherein the session identification information comprises a session identification and a user identification.

3. The method of claim 1, wherein the plurality of session details comprise a plurality of web pages navigated by the user during the session.

4. The method of claim 3, wherein the agent help information includes the plurality of web pages navigated by the user during the session, and wherein the plurality of web pages are organized in the agent help information according to an order in which the user navigated the plurality of web pages.

5. The method of claim 1, wherein the agent help information includes the plurality of session details organized according to an order in which the user generated the plurality of session details.

6. The method of claim 1, wherein the receiving the plurality of session details related to the session involving the user further comprises:
determining that the user has logged into the session; and
recording, by the session server, the plurality of session details until it is determined that the user has logged out of the session, wherein the plurality of session details include each of a plurality of web pages navigated by the user during the session.

7. The method of claim 1, wherein the receiving, by the backend server through the network, the help request from the user and session identification information further comprises:
receiving, by a help engine through the network, the help request from the user;
capturing, by the help engine, the session identification information from a web page in response to receiving the help request; and
sending, by the help engine to the backend server, the help request from the user and the session identification information.

8. The method of claim 1, wherein the session server and the backend server are combined on a single server.

9. A machine-readable medium comprising a plurality of machine-readable instructions which when executed by one or more processors of one or more servers are adapted to cause the one or more servers to perform a method comprising:
receiving a plurality of session details related to a session involving a user;
receiving a help request from a user and session identification information;
retrieving the plurality of session details using the session identification information;
creating agent help information that includes the plurality of session details;
associating the agent help information with the help request; and
sending the agent help information and the help request to a help agent device.

10. The machine-readable medium of claim 9, wherein the session identification information comprises a session identification and a user identification.

11. The machine-readable medium of claim 9, wherein the plurality of session details comprise a plurality of web pages navigated by the user during the session.

12. The machine-readable medium of claim 11, wherein the agent help information includes the plurality of web pages navigated by the user during the session, and wherein the plurality of web pages are organized in the agent help information according to an order in which the user navigated the plurality of web pages.

13. The machine-readable medium of claim 9, wherein the agent help information includes the plurality of session details organized according to an order in which the user generated the plurality of session details.

14. The machine-readable medium of claim 9, wherein the receiving the plurality of session details related to the session involving the user further comprises:
determining that the user has logged into the session; and
recording the plurality of session details until it is determined that the user has logged out of the session, wherein the plurality of session details include each of a plurality of web pages navigated by the user during the session.

15. The machine-readable medium of claim 9, wherein the receiving the help request from the user and session identification information further comprises:
receiving the help request from the user; and
capturing the session identification information from a web page in response to receiving the help request.

16. An on-line help system comprising:
means for receiving a plurality of session details related to a session involving a user;
means for receiving a help request from a user and session identification information;
means for retrieving the plurality of session details using the session identification information;
means for creating agent help information that includes the plurality of session details;
means for associating the agent help information with the help request; and
means for sending the agent help information and the help request to a help agent device.

17. The system of claim 16, further comprising:
means for determining that the user has logged into the session; and
means for recording the plurality of session details until it is determined that the user has logged out of the session, wherein the plurality of session details include each of a plurality of web pages navigated by the user during the session.

18. The system of claim 16, further comprising:
means for receiving the help request from the user; and
means for capturing the session identification information from a web page in response to receiving the help request.

19. The system of claim 16, wherein the plurality of session details comprise a plurality of web pages navigated by the user during the session.

20. The system of claim 19, wherein the agent help information includes the plurality of web pages navigated by the user during the session, and wherein the plurality of web pages are organized in the agent help information according to an order in which the user navigated the plurality of web pages.
